(19) United States
(12) Patent Application Publication
(10) Pub. No.: US 2016/0042339 A1
(43) Pub. Date: Feb. 11, 2016

(54) INTELLIGENT TIPPING

(71) Applicant: EBAY INC, San Jose, CA (US)

(72) Inventor: Timothy C. Nichols, Los Altos, CA (US)

(21) Appl. No.: 14/452,458

(22) Filed: Aug. 5, 2014

(51) Int. Cl. G06Q 20/22; G06F 17/30

(52) U.S. Cl. CPC G06Q 20/22; G06F 17/3097; G06F 17/30867

(57) ABSTRACT

Methods and systems for providing a gratuity or tip to a merchant are described. A service provider provides suggested gratuity or tip amounts and/or incentives or motivations to a user to provide a gratuity. For example, the service provider can provide statistics regarding how much consumers usually tip (e.g., average tip, standard tip, etc.), how much a consumer like the user tips (e.g., similar demographics, similar spending patterns, similar number of visits to the merchant, etc.), and how much money has been collected so far to reach a goal. In addition, the service provider can indicate that the gratuity or portion of the gratuity will be donated to charity.

### BACKGROUND

1. Field of the Invention

The present invention generally relates to providing a tip or gratuity to a merchant.

2. Related Art

Tipping is an essential means for compensating workers in many different industries. Tips boost company morale, supplement workers' wages, and give customers a channel through which to show their appreciation for good service. For service-oriented companies—companies for which tipping is a central aspect of the customer's daily experience—employees are the face of the company to customers and almost completely dictate customer satisfaction. Over the past several years, as an easy way to accept tips from customers, tip jars have found their way onto the counters of many establishments that customarily would not have solicited tips from their customers including coffee shops, delis, fast food restaurants, retail stores and other for-profit businesses and non-profit organizations. Additionally, cash collection receptacles resembling tip jars in form and function are also widely used by charitable organizations that solicit small donation amounts from passers-by.

Some customers feel that tip jars are inappropriate at certain types of establishments. Others feel social pressure to use them, or that they are paying too high a total price when purchasing a simple item. Still others may not know the proper amount to tip, especially in situations that are less governed by industry standards (i.e., customary 15% to 20% tip for sit-down restaurants, where the customer orders, is served, and pays at a table using a wait person). It is therefore often a challenge to encourage people to provide tips.

Thus, a need exists for systems and methods that encourage the giving of tips and in a proper amount.

### BRIEF DESCRIPTION OF THE FIGURES

FIG. 1 is a block diagram illustrating a system for providing a gratuity to a merchant according to an embodiment of the present disclosure;

FIG. 2 is a flowchart showing a method for providing a gratuity to a merchant according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for providing a gratuity. In various embodiments, a service provider provides suggested gratuity or tip amounts, and/or incentives or motivations to the user to provide a gratuity. For example, the service provider can provide statistics regarding how much consumers usually tip (e.g., average tip, standard tip, etc.) for a particular purchase, service, or merchant type, how much a consumer like the user tips (e.g., similar demographics, similar spending patterns, similar number of visits to the merchant, etc.), how much similarly situated employees make and/or rely on tips, and/or how much money has been collected so far to reach a goal. With this type of information, the consumer may be more likely to provide a tip and at a proper amount.

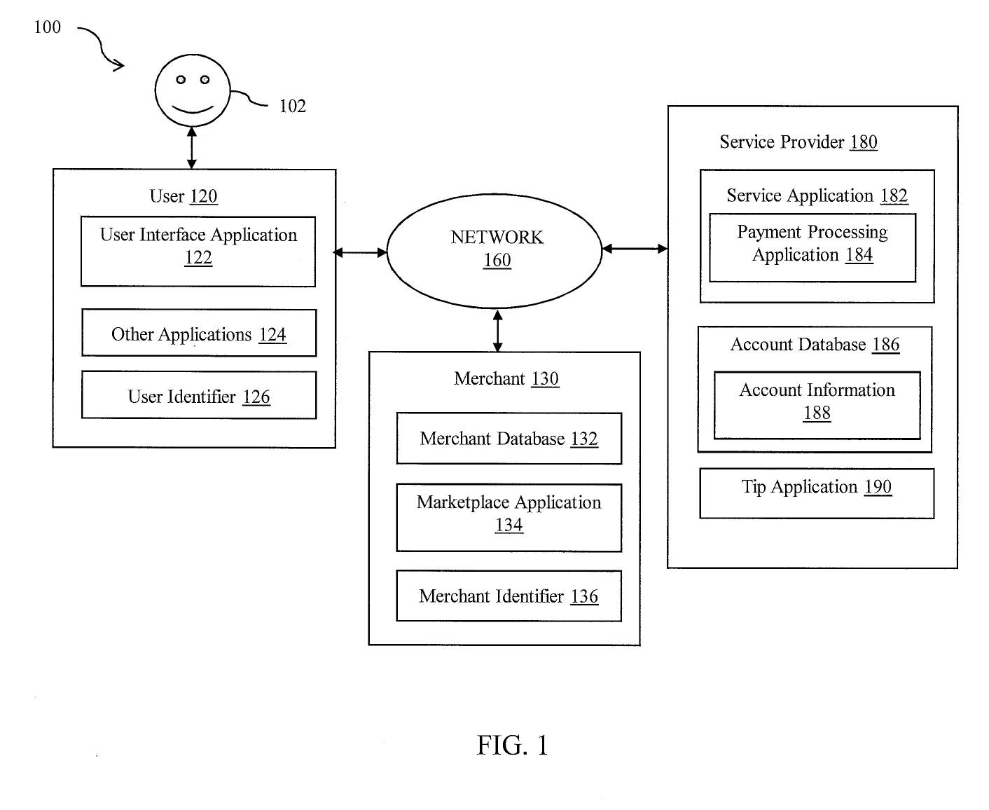

FIG. 1 shows one embodiment of a block diagram of a network-based system 100 adapted to provide a tip to a merchant with a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more merchant servers or devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 120, in one embodiment, may be utilized by the user 102 to interact with the merchant server or device 130 and/or the service provider server 180 over the network 160. For example, the user 102 may conduct financial transactions (e.g., account transfers) with the service provider server 180 via the user device 120. The user device 120, in various embodiments, may be implemented using any appropriate combination of hardware and/or software configured for wired and/or wireless communication over the network 160. In various implementations, the user device 120 includes a wireless telephone (e.g., cellular or mobile phone), a tablet, a personal computer, a notebook computer, a wearable computing device, and/or various other generally known types of wired and/or wireless computing devices.

The user device 120, in one embodiment, includes a user interface application 122, which may be utilized by the user 102 to conduct transactions (e.g., shopping, purchasing, bidding, tipping, etc.) with the merchant server or device 130 and/or service provider server 180 over the network 160. In one aspect, purchase expenses and/or tips may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In various embodiments, the user interface application 122 presents tipping suggestions to the user 102 and/or provides information that encourages the user 102 to provide a tip.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items and include a tip) from the one or more merchant servers 130 via the service provider server 180.

The user device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the user device 120 (e.g., cell phone). The user profile may be updated with each financial and/or information transaction (e.g., payment transaction, purchase transaction, tip transaction, etc.) achieved through use of the user device 120. In various aspects, this may include the type of transaction and/or the location information from the user device 120. As such, the profile may be used for recognizing patterns of potential fraud, setting transaction limits on the user, etc.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering items to the user 102 over the network 160. As such, each of the one or more merchant servers 130 may include a merchant database 132 for identifying available items, which may be made available to the user device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the user device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. The merchant identifier 136 may include attributes related to the merchant server or device 130, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to a merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of the service provider as a payment intermediary. The merchant website may also have an account with the service provider.

The service provider server 180, in one embodiment, may be maintained by a transaction processing entity or an online service provider, which may provide processing for financial transactions and/or information transactions between the user 102 and one or more of the merchant servers 130. As such, the service provider server 180 includes a service application 182, which may be adapted to interact with the user device 120 over the network 160 to facilitate the searching, selection, purchase, and/or payment of items by the user 102 from the one or more merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing application 184 settles indebtedness between the user 102 and each of the merchant servers 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., user 102) and merchants. For example, account information 188 may include private financial information of user 102 and merchants (e.g., one or more merchants associated with merchant servers 130), such as one or more account numbers, passwords, credit card information, banking information, or other types of financial information, which may be used to facilitate financial transactions between user 102, and one or more merchants associated with the merchant servers 130. The account information 188 may also include personal information, such as one or more contact information (e.g., a phone number, address, or an email) and other account IDs of the user 102 that are maintained by third parties (e.g., user names or account numbers). In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes a tip application 190. The tip application 190 keeps track of the users that have tipped at a merchant, as well as the amount provided by each user. The tip application 190 collects and organizes this data so that it can be easily accessed when needed. In some embodiments, the tip application 190 communicates statistics and suggested tip amounts to the user 102, and processes payment of the tips to the merchant. In certain embodiments, the tip application 190 also provides information that prompts the user 102 to include a tip, such as characteristics of an employee providing the service. For example, the tip application 190 may inform the user 102 of recent purchases of the employee, such as maternity or baby clothes, a car, tuition, medical bills, etc., and/or how much of the employee's salary is derived from tips.

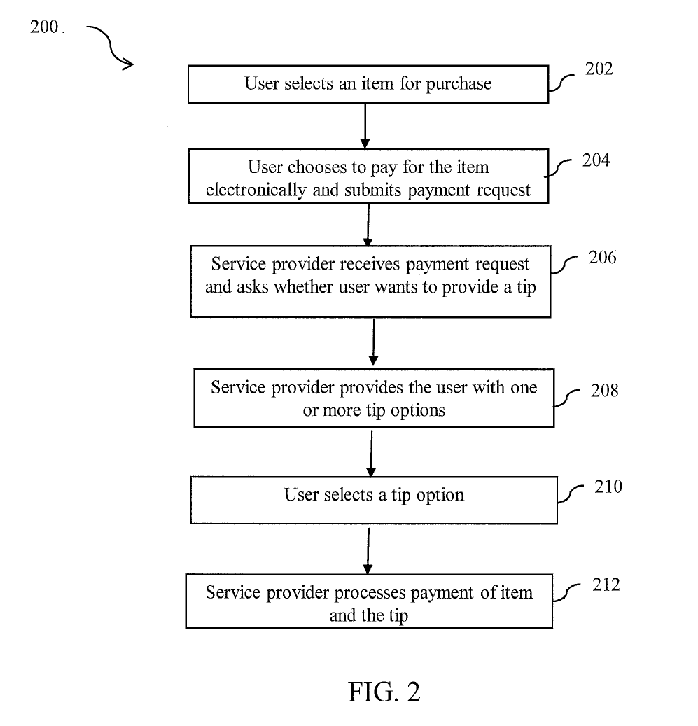

Referring now to FIG. 2, a flowchart of a method 200 for providing a tip or gratuity to a merchant is illustrated according to an embodiment of the present disclosure. At step 202, the user 102 enters a merchant store or accesses a merchant website, and selects an item for purchase.

At step 204, the user 102 chooses to pay for the item item (which can include services, like car washes, shoe shines, valet parking, haircuts, spa services, etc.) electronically. For example, the user 102 can pay through use of a mobile application on the user device 120, use of a Quick Response (QR) code, barcode or other code, etc. In certain embodiments, the user 102 logs in or otherwise accesses a service provider site on the user device 120 and makes a payment request. This may include entering a password or PIN for the user's account with the service provider. The request may include information about the merchant who is to receive the payment.

At step 206, the service provider server 180 receives the payment request and asks whether the user 102 would like to add a tip. The tip application 190 receives an indication of a potential tipping event. Other potential tipping events include a request for tipping information or detection that the user 102 has entered a merchant location that accepts tips. A tip may be a sum of money or other consideration that is provided on top of the money or consideration requested by a merchant for a product or service. For example, the user 102 can provide a merchant a tip in the amount of $1 for a $3 cup of coffee. The user 102 can choose to combine the cost of the item with the tip in one transaction, or choose to separate the cost of the item and the tip into two transactions. The tip and item/service purchase may also be in different payment formats. For example, the tip may be electronic and item/service purchase may be cash or vice versa. The tip and item/service purchase may also be processed by different payment providers. For example, the item/service may be paid using a credit card, while the tip may be made using a third party payment provider, such as PayPal®, Inc. of San Jose, Calif.

Prior, during, or after the processing of the transaction for the item, the user 102 can be provided with the option to provide the merchant a gratuity or tip. In certain embodiments, the user 102 requests tip suggestions and/or relevant information regarding why to tip (e.g., the employee is expecting a baby and would benefit from extra money). At step 208, the service provider server 180 provides the user 102 with one or more tip options (e.g., tip amounts), and from the one or more tip options, at step 210, the user 102 may make a tip selection. The one or more tipping options can include one or more tipping amounts, a tipping field in which the user 102 may enter a tip amount, the option to tip at a later point in time, and/or the option to not provide the merchant a tip.

The user 102 can also elect various settings, which can enable the service provider server 180 to provide the user 102 the option to tip a merchant prior to, during or upon the completion of the processing of a transaction between the user 102 and the merchant. The user 102 can provide the merchant a tip amount from tipping options selected by the service provider server 180, the merchant, or inputted by the user 102.

In some embodiments, the service provider server 180 provides statistics regarding the average or most common tip for the merchant, and the one or more tip options are based on these statistics. For example, the service provider server 180 can show the user 102 that 38% of all customers provided tips in an average amount of $1.25 for that day, week, month, and/or year. In another example, the server 180 may indicate to the user 102 that most customers tip 17.5% at the merchant or for the specific employee. In yet another example, the service provider server 180 displays to the user 102 that 80% of users tip the merchant $5 or more for each visit. The average amounts can be broken down into amount spent for the item/service or other factors described in more detail below.

In various embodiments, the user 102 may indicate that he or she wants advice on a tip or gratuity to be provided. For example, the user 102 may request information for a suggested gratuity or tip, and the server 180 can present the suggested tip as the one or more tip options. The suggested gratuity may be based on user preferences, be derived from a knowledge base containing information regarding tipping customs or protocols in different countries or locations, be based on previous user interactions with the same or a similar merchant (e.g., tipping history), or be based on another suitable source of information or combination of sources of information. For example, tip application 190 may include or have access to data (typically contained in a searchable or indexed database) relating to, among other topics: standard gratuity amounts (e.g., based on a percentage or percentages of the cost); tipping customs based on geographical location; tipping customs based on time of year (e.g., Christmas, New Year's Day, Thanksgiving, etc.), time of day (e.g., morning, afternoon, evening), and/or time of week (e.g., weekday or weekend); suggested tip amounts based on characteristics of a location or merchant (e.g., based on merchant, type of service provided, or merchant category, where the category may be defined by a rating or average cost); previously provided user preferences for tipping in certain situations; suggested tip amounts based on the transactions of similar consumers with the same or a similar merchant or category of merchant, as determined by certain characteristics of the consumer (demographic data, spending habits, number of merchant visits, purchase history, etc.); suggested tip amounts based on what similarly situated employees make and/or how much they rely on tips as their total compensation (for example, a higher tip may be suggested if the employee is paid a very low base compensation and relies on tips as the main source of compensation); or suggested tip amounts based on customers whom the user has indicated are representative of the user (such as friends, members of a common network, social network or group, etc.). For example, the suggested tip may be based on data that shows that customers in the same income bracket, that drive a similar vehicle, and that purchased a similar item as the user 102 contributed $2 to the tip. In a different example, the suggested tip is based on statistics that show that 90% of customers provided a $1 tip at the specific merchant or a similar category of merchant. In yet another example, it is the evening of Christmas Eve, and the suggested tip is based on customers providing 30% of the cost of the item as a tip during the holiday season.

In certain embodiments, the tip application 190 provides information to the user 102 that will likely spur the user 102 to give a tip. For example, information regarding employee base salary, recent employee purchases (e.g., medicines, baby clothes, car, textbooks, etc.), and information about where the tips go (e.g., charities supported by the merchant, local sports teams supported by the merchant, events sponsored by the merchant, etc.)

In some embodiments, the user 102 can provide a tip before the user 102 knows the total transaction amount. Alternatively, the user 102 can provide the tip after knowing the transaction amount, but before closing the tab with the merchant. In some situations, the user 102 can provide the tip after knowing the transaction amount and closing the tab with the merchant.

In various embodiments, a tip jar is used to collect tips. The tip jar may be a physical tip jar or an electronic tip jar. Tip jars are typically present at places where a user orders at the counter, such as a sandwich shop, donut shop, bakery, coffee shop, ice cream parlor, or bar. Places such as sit-down restaurants usually do not solicit tips or gratuities in a tip jar.

In an embodiment, the service provider server 180 can show how much money has already been collected in a tip jar for the merchant. For example, the service provider server 180 may display an icon of a jar showing how full the jar is and how much money customers have provided on a daily, weekly, monthly, and/or yearly basis. The fact that other customers have already tipped can encourage the user 102 to provide a tip.

In some embodiments, a thermometer graphic may be displayed to the user 102 in association with the tip jar to show the progress of reaching a certain goal. For instance, if a merchant has a goal of receiving a certain amount of tips, the merchant may include a thermometer style widget graph which increases toward the goal to show how much has been given so far. The merchant may indicate that the tips or a certain percentage of the tips will go to a specific charity once the goal is reached. Donating to charity is another way to motivate individuals to give tips.

In certain embodiments, after the user 102 leaves a tip, he or she can leave a note on the tip jar. For example, the user 102 may choose to leave a note with an icon (such as a smiley face, a heart, a food or drink item, etc.), a word of encouragement, a recommended item, or even a funny joke. When another user adds a tip to the tip jar, the other user may access and read the notes left on the tip jar. Allowing a user to leave a personalized note may also motivate users to contribute a tip to the tip jar.

At step 212, the service provider processes payment of the item and the tip. For example, a user account is debited and amount credited or transferred to a merchant account. In various embodiments, payment for the item is credited to the merchant account, but the tip is placed in a separate tip account associated with the merchant. The merchant account information may be contained or obtained from the payment request. The item/service payment and/or the tip need not be processed by the service provider. For example, the item/service payment may be processed by the service provider, while the tip may be paid to the employee/merchant directly by the user, such as with cash, based on the information provided by the service provider.

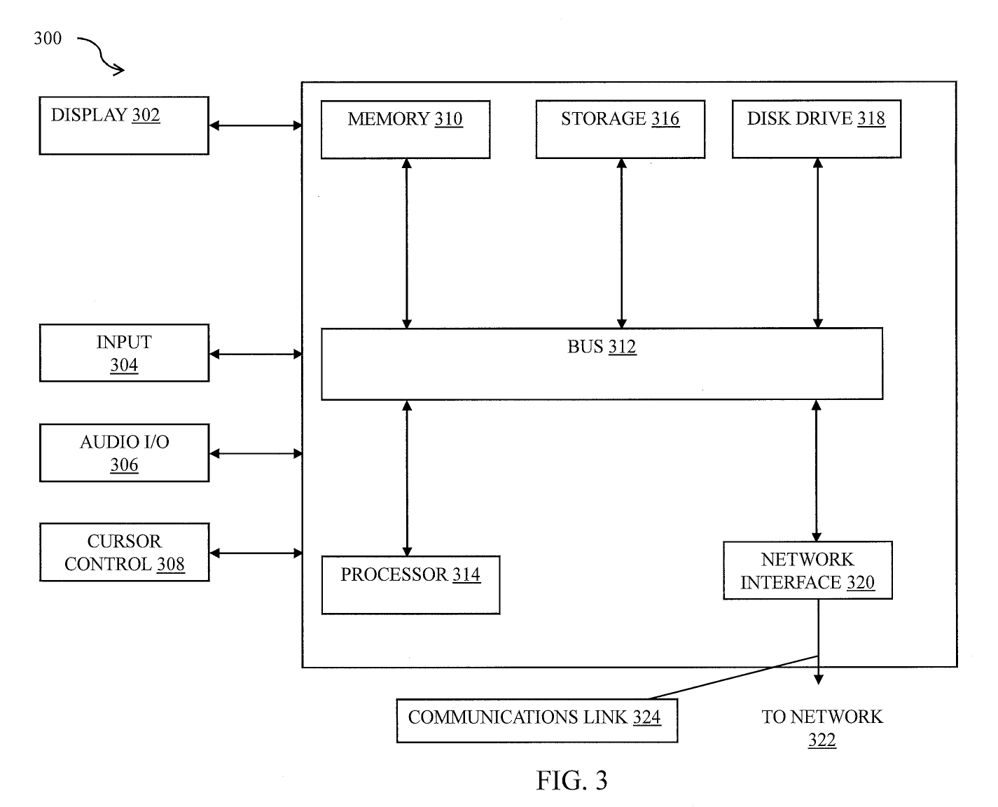

FIG. 3 is a block diagram of a computer system 300 suitable for implementing one or more embodiments of the present disclosure, including the user device 120, merchant server 130, and the service provider server 180. In various implementations, the user device 120 may comprise a mobile cellular phone, personal computer (PC), laptop, wearable computing device, etc. adapted for wireless communication, and the merchant server 130 and service provider server 180 may comprise a network computing device, such as a server. Thus, it should be appreciated that the devices 120, 130, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, service provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). Display 302, in various embodiments presents user 102 with suggested tip amounts. An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a service provider server via network 322. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. For example, processor 314 can receive payment requests from a user, present the user with one or more suggested tip amounts, receive a user's selection of a tip amount, and process the payment requests. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

In view of the present disclosure, it will be appreciated that various methods and systems have been described according to one or more embodiments for providing a gratuity to a merchant.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory storing merchant gratuity information; and
one or more processors in communication with the memory and operable to:
receive an indication of a tipping event;
access data relevant to the tipping event;
determine a suggested gratuity based on the data; and
present the suggested gratuity to the user.

2. The system of claim 1, wherein the one or more processors are further operable to provide information to motivate the user to provide a gratuity.

3. The system of claim 2, wherein the information comprises how the gratuity will be used, employee information, or a combination thereof.

4. The system of claim 1, wherein the data comprises customer statistics.

5. The system of claim 4, wherein the customer statistics comprise average tips, standard tips, or both.

6. The system of claim 4, wherein the customer statistics comprise tipping customs based on one or more of location of, time of day, day of the week, characteristics of the merchant, similar consumers, or consumers in the user's network.

7. The system of claim 1, wherein the one or more processors are further operable to to process payment of the suggested gratuity.

8. The system of claim 7, wherein the one or more processors are further operable to deposit the suggested gratuity in a tip jar.

9. A method of providing a gratuity to a merchant, comprising:
receiving, by one or more hardware processors of a service provider, a payment request from a user;
providing, by the one or more hardware processors, at least one incentive to the user to provide a gratuity;
receiving, by the one or more hardware processors, a gratuity amount from the user; and
processing, by the one or more hardware processors, the payment request.

10. The method of claim 9, wherein the at least one incentive comprises one or more of providing tipping statistics, displaying how much money has been collected in a tip jar, displaying a graphic that indicates progress of reaching a goal, indicating that the gratuity or a portion of the gratuity will be donated to charity, allowing the user to associate a personalized note with a tip jar, and providing employee information.

11. The method of claim 10, wherein the tipping statistics comprise one or more of average tips, standard tips, and tipping customs based on one or more of location of, time of day, day of the week, characteristics of the merchant, similar consumers, or consumers in the user's network.

12. The method of claim 10, wherein the employee information comprises one or more of recent employee purchases, employee base salary, or a combination thereof.

13. The method of claim 9, further comprising suggesting a gratuity amount to the user.

14. The method of claim 13, wherein the suggested gratuity amount is based on customer statistics.

15. A non-transitory machine-readable medium comprising instructions which, in response to a computer system, cause the computer system to perform a method comprising:
receiving a payment request from a user;
providing information to motivate the user to provide a gratuity;
determining one or more suggested gratuities based on tipping customs; and
presenting the one or more suggested gratuities to the user.

16. The non-transitory machine-readable medium of claim 15, wherein the tipping customs are based on one or more of location of, time of day, day of the week, characteristics of the merchant, similar consumers, or consumers in the user's network.

17. The non-transitory machine-readable medium of claim 16, wherein the similar consumers comprise consumers who share similar demographic data, spending patterns, or both with the user.

18. The non-transitory machine-readable medium of claim 15, wherein providing information to motivate the user comprises displaying how much money has been collected and displaying a graphic to show progress of reaching a goal.

19. The non-transitory machine-readable medium of claim 15, wherein the method further comprises processing payment of a suggested gratuity.

20. The non-transitory machine-readable medium of claim 19, wherein the method further comprises depositing the suggested gratuity in a tip jar.
